(19) United States
(12) Patent Application Publication
(10) Pub. No.: US 2005/0021817 A1
(43) Pub. Date: Jan. 27, 2005

(54) Digital content delivery, server and client

(75) Inventors: Shuichi Shimizu, Yokohama-shi (JP); Ryo Sugihara, San Diego, CA (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/884,137

(22) Filed: Jul. 2, 2004

(30) Foreign Application Priority Data
Jul. 3, 2003 (JP) 2003-270818

(51) Int. Cl. G06F 15/16

(52) U.S. Cl. 709/231

(57) ABSTRACT

Has the same digital content shared by all clients connected to local networks just by sending the smallest packet required to reconstitute the digital content from a server. A digital content delivery system of the present invention includes clients for constituting second networks and connected to a first network and receiving and providing the digital content. A server includes a client list for storing address identification values of the clients participating in the second network constituted as a collision domain and a device for randomly selecting client identification values registered with the client list, and sends to a selected client a packet as a minimum unit for constituting the digital content in response to the selection.

### FIELD OF THE INVENTION

The present invention relates to delivery of digital content from a server via a network to clients connected to a plurality of local networks. To describe it in detail, the present invention relates to a digital content delivery system, a digital content delivery method, a server and a client for the same, a computer-executable program for controlling a computer as a server, and a computer-executable program for controlling a computer as a client capable of having the same digital content shared by all the clients connected to the local networks just by sending from the server the smallest packet required by the server to reconstitute the digital content.

### BACKGROUND ART

In recent years, networks such as the Internet via methods such as a computer, a public telephone circuit, ISDN, optical communication, radio communication, ADSL and CATV are increasingly diffusing. As for the future, it is thinkable that there will be further diffusion of not only delivery of digital content such as e-mail but service of delivering text data, voice data, image data and multimedia data combining them via the networks from the server placed on a site for providing the digital content to a plurality of computers or clients such as portable terminals.

Various techniques have been proposed so far for the sake of one-to-many data communication. However, there have arisen various problems combined with diversification of computer apparatuses and network environments. FIGS. 19 and 20 show representative techniques in the cases of performing the above-mentioned one-to-many data delivery in the past. To describe the prior art by using FIGS. 19, FIG. 19(a) shows a data delivery process using a unicast, and FIG. 19(b) shows the data delivery using an IP multicast. As for the data delivery using the unicast shown in FIG. 19(a), in the case of assuming that the data is delivered through a network 100, the number of clients 102 as destinations increases and the number of data streams for having the same data shared also increases in proportion thereto. For this reason, the same data of different destinations is redundantly communicated via the network 100 so that it causes congestion of the network 100 or a router defining a predetermined domain connected to the network 100. The same inconvenience also occurs to a delivery server 104, and there arises a problem that a load of the delivery server 104 becomes larger as the number of clients 102 increases.

FIG. 19(b) shows an overview technique of the IP multicast proposed as a method of solving the problem of the unicast. As for the IP multicast, the network 100 has dedicated router 106 connected thereto. As for the dedicated router 106, if the delivery server 104 sends the data stream to a predetermined multicast address, the dedicated router 106 on a network 100 path receives the packet so as to have the data delivery executed with the packet to a plurality of clients 102 registered with a multicast address.

In this case, only a single data stream flows among the dedicated routers 106 regardless of the number of the clients 102 so that the congestion of the network is prevented and the load of the server is significantly alleviated. To use the IP multicast, however, it is essential to replace all the routers on the path with the dedicated routers 106. And it requires enormous capital investment because of essential investment in an infrastructure. Furthermore, there are many cases where the dedicated router 106 supporting the IP multicast has a setup not to pass a multicast packet operationally. For this reason, the delivery by the IP multicast is not realistic in many cases.

As a method of solving the above problem of the IP multicast, there is “Multicast Tunneling” represented by MBone. It links the networks passing no multicast with virtual tunnels by the unicast so that the multicast packet is delivered. This method has the tunnels constituted by the computers for constituting them, and so it requires a daemon process to constantly function. Use of the Multicast Tunneling expands an applicable scope compared to the cases of using only the IP multicast. However, a number of problems accompanying the IP multicast such as necessity of infrastructure support and difficulty of routing are not completely solved yet. Furthermore, the IP multicast has a problem that addresses are uniquely determined the world over and so it is difficult to perform the delivery to a limited domain. This problem also applies to the Multicast Tunneling.

Small Group Multicast (XCast) is also known as a deformed example of the IP multicast. As for the Small Group Multicast (XCast), a list of all the destinations is described in the packet so that the router supporting SGM existing on the network interprets the packet and individually performs the unicast. This method is characterized in that the router not supporting SGM can exist in between, implementation is simple compared to the IP multicast, and a delivery scope can be defined. However, this method is a technology for performing simultaneous delivery to a small group as its name indicates. Therefore, if the group becomes larger to a certain extent, the destination list becomes enlarged and the load per packet becomes significant, resulting in a limited applicable scope.

FIG. 20 schematically shows a data delivery technique to be referred to as a so-called application-level multicast. The application-level multicast shown in FIG. 20 is a generic term for the technology for implementing an operation equivalent to the IP multicast on a client application. According to the application-level multicast, the server 104 uses the unicast to send the data to a single client 102 or a few of clients 102. On receiving the data delivery, a client 102a transfers the data to other clients 102b to 102f and eventually has the data thereby shared by all the clients. Such an application-level multicast is characterized by requiring no additional investment in the infrastructure. However, it has a drawback that an update to a delivery route according to change in client configuration normally becomes complicated.

Furthermore, in the case where a role of the client is fixed in the application-level multicast, there arises an essential problem that, if the client positioned upstream breaks away from the local network or suddenly goes down, the data is not delivered to downstream clients. To solve this problem, it is thinkable to cope with it by operating the daemon process for performing only a transfer to each client even when the client does not need to receive any delivery. It is not possible, however, to cope with it by this method in the case where a failure occurs to the client or the client breaks away physically like a hot spot of a wireless LAN.

The following documents are to be considered:
Non-Patent Document 1
“Multicast, Routing in Internetworks and Extended LANs” (Stanford University, Department of Computer Science Technical Report: STAN-CS-88-1214, July 1988).
Non-Patent Document 2
Small Group Multicast (XCast) Rick Boivie et al., “Small Group Multicast: A New Solution for Multicasting on the Internet,” IEEE Internet Computing, May/June 2000, pp. 75 to 77.
Non-Patent Document 3
Dimitrios Pendarakis, Sherlia Shi, Dinesh Verma, and Marcel Waldvogel. Almi: An application level multicast infrastructure. In Proceedings of the 3rd USENIX Symposium on Internet Technologies and Systems (USITS), pages 49 to 60, 2001.
Non-Patent Document 4
Y. Chu, S. Rao and H. Zhang. A Case for End System Multicast. In Proc. ACM Sigmetrics, June 2000.
Non-Patent Document 5
P. Francis, “Yoid: extending the internet multicast architecture,” preprint available from http://www. isis. edu/div7/yoid/, April 2000.
As one method of solving these problems, the inventors hereof proposed a new data delivery method in the following Patent Document 1.
Patent Document 1
Japanese Patent Application No. 2002-303850
Hereafter, the data delivery disclosed in the above specification will be referred to as “P2G (Peer-to-Group) type data delivery.” FIG. 21 is a diagram schematically showing a technique of the P2G type data delivery disclosed in Japanese Patent Application No. 2002-303850. The P2G type data delivery sends the packet by the unicast from the server 104 to one of the clients 102. Thereafter, it uses the unicast to share the P2G type data in the “domain” comprised of a plurality of clients so as to deliver the data to the entire clients. Furthermore, it randomly changes the destination client for sending the data from the delivery server first so as to realize robustness of the delivery system as well as load sharing.

### PROBLEMS TO BE SOLVED BY THE INVENTION

As a result of a review by the inventors hereof, however, it was found out that there are the cases where the above-mentioned P2G type data delivery is not necessarily efficient in a collision domain (non-switching environment) such as a wireless LAN and a wired LAN consisting of repeater hubs. FIGS. 22 schematically describe inconvenience arising in the collision domain. FIG. 22(a) is a diagram schematically showing a traffic route of the P2G-type data delivery using a switching means. FIG. 22(b) is a diagram schematically showing the inconvenience arising in the collision domain. As shown in FIG. 22(a), in the case of the P2G type data delivery using the switching means such as a switching hub, the packet is only sent to a port to which a destination terminal is connected, and so there is not much inconvenience arising to communication in the domain of the data sent by the P2G type data delivery.

As for the collision domain shown in FIG. 22(b), the communication between any two clients reaches all the other clients in addition to the applicable client F. For this reason, even if the smallest number of packets are sent by using the P2G type data delivery, the same packet is sent to a predetermined client after all, for example, the same packet is sent (n-1) times to the client F. In this case, the client F selects and takes in only the data addressed to itself, but the communication of all the other clients is interfered while transferring communication packets.

To describe it more concretely, in the case where the P2G type data delivery is applied in a network of the non-switching environment such as the domain comprised of the wireless LAN, repeater hub/bridge and so on for instance, one-to-one communication prevails at least once in the entire collision domain in addition to the destination. For this reason, a lot of packets (O(n²), n is the number of clients) which influence the clients other than the destination client for sharing the P2G type data are redundantly communicated in the collision domain.

It means that, assuming that the P2G type data delivery is performed to the network including the wireless LAN environment, a network bandwidth is wastefully consumed so as to cause a problem in the collision domain such as reduction in the entire communication speed. In addition, while communicating a predetermined communication packet from one client to another client, the communication between the clients not related thereto is interfered.

As described above, it can be said that, in the case of a so-called collisionless domain in which the clients in the domain are connected by switch means such as the switching hub, the P2G type data delivery is highly efficient and is also robust against the change in client configuration. In the case of the collision domain (non-switching environment), however, it was found out as a result of a further review by the inventors hereof that there is the inconvenience of the limited applicable scope because of inefficient communication in the collision domain as described above. Therefore, it was found out that the P2G type data delivery in the past requires a method of delivering the data efficiently to a large number of clients in a network environment referred to as the collision domain while reducing additional investment in the infrastructure as much as possible.

### SUMMARY OF THE INVENTION

Therefore, the present invention provides improved efficiency in a network environment using no switching means in the above P2G type data delivery. According to an aspect of the present invention, it assumes that a server is connectable to all or a part of destination clients so that the server sends a source packet to any one client by a unicast. The client having received it transfers a copy packet to a predetermined local multicast address. All the clients receiving delivery service can access this multicast address. For this reason, it is possible for all the clients to constantly receive the packets regardless of which client first received the packet directly from a delivery server.

Furthermore, according to the present invention, the server randomly changes the client for sending the packet first so that, the larger the number of clients becomes, the lower the frequency with which each client sends the copy packet to the multicast address becomes in inverse proportion to the number of clients. For this reason, the load among the clients is shared, and at the same time, it becomes easier to cope with a specific client participating in or pulling out of the network. It is also possible, as the clients operate in collaboration to allow sharing of digital content, to eliminate necessity of additional investments such as a secondary server in a corresponding collision domain.

Another aspect of the present invention is to provide a method for delivering the digital content via the first network and the second network, a digital content delivery method including the steps of:
having the packet as the minimum unit for constituting the digital content received via the above described first network by the client attributed to the above described second network to be selected by a server connected to the above described first network in response to the network environment of the above described second network;
having a copy packet of the above described packet as the minimum unit created by the above described client having received the above described packet as the minimum unit; and
having the above described created copy packet multicast from the above described client to the second network to which the above described client is attributed and having the above described packet as the minimum unit shared by all the clients attributed to the above described second network.

In another aspect, the present invention also provides a server used for the system for delivering the digital content via the first network and the second network.

The present invention also provides a computer-executable program for controlling a computer as the server for executing the digital content delivery method via the first network and the second network.

Furthermore, the present invention provides the computer-executable program for controlling a computer as a client for delivering the digital content via the first network and the second network.

### BRIEF DESCRIPTION OF THE DRAWINGS

These and other objects, features, and advantages of the present invention will become apparent upon further consideration of the following detailed description of the invention when read in conjunction with the drawing figures, in which:

FIG. 1 is a schematic diagram of a digital content delivery system of the present invention;

FIG. 2 is a diagram showing an embodiment of sending of a source packet and a copy packet in the case of sending the source packet from a server to a collision domain in the digital content delivery system shown in FIG. 1;

FIG. 3 is a diagram showing a schematic configuration of the source packet usable for the present invention;

FIG. 4 is a diagram showing a schematic embodiment of the copy packet usable for the present invention;

FIG. 5 is a diagram showing a schematic configuration of the server of the present invention;

FIG. 6 is a diagram showing the embodiments of a client list (a) and a domain list (b) usable for the present invention;

FIG. 7 is a diagram showing a transmission buffer used for the present invention and an occupation state of a queue stored in the transmission buffer;

FIG. 8 shows a schematic flowchart of the process performed by the server;

FIG. 9 is a diagram showing a configuration of the client usable for the present invention;

FIG. 10 is a schematic flowchart of the process up to receiving the source packet and sending out the copy packet by the client according to the present invention;

FIG. 11 is a diagram showing the process of the server for performing the P2G type data delivery in a network system in which the collisionless domain and the collision domain are mixed;

FIG. 12 is a diagram showing a more concrete embodiment of the content delivery system of the present invention;

FIG. 13 is a diagram showing the embodiment in the case where the collision domain of the present invention is the network using wireless communication;

FIG. 14 is a diagram showing the transactions among the client, access point and P2G server in chronological order in the case where the collision domain is constituted as a wireless LAN;

FIG. 15 is a diagram showing the transactions in the case of including the collisionless domain and the collision domain in chronological order;

FIG. 16 is a diagram showing the transactions in the case of killing the connection between the client and P2G server;

FIG. 17 is a diagram showing the transactions in the case of killing the connection between the client and P2G server;

FIG. 18 is a diagram showing the transactions in the case of killing the connection between the client and P2G server;

FIGS. 19 are diagrams showing a representative technique in the case of performing one-to-many data delivery in the past;

FIGS. 20 are diagrams showing a representative technique in the case of performing the one-to-many data delivery in the past;

FIG. 21 is a diagram schematically showing a technique of the P2G type data delivery; and

FIGS. 22 are diagrams schematically describing inconvenience arising in the collision domain.

### DESCRIPTION OF SYMBOLS

10 . . . Digital content delivery system
12 . . . Network
14 . . . Server
16 . . . Router
18 . . . Switching hub
20 . . . Clients
22 . . . Second network
24 . . . Network equipment
26 . . . Collision domain
28 . . . Second network
30 . . . Source packet
32 . . . Copy packet
34 . . . Communication means
36 . . . Storage device
38 . . . CPU
40 . . . Source encoder
42 . . . FEC encoder
44 . . . Client selection means
46 . . . Memory
50 . . . Client list
56 . . . Domain list
60 . . . NIC
62 . . . Receiving buffer
64 . . . Memory
66 . . . CPU
68 . . . Source decoder
70 . . . FEC decoder
72 . . . Display
74 . . . Storage device
80 . . . P2G server
82 . . . Network
84 . . . Switching hub
86 . . . Local network
88 . . . Repeater/bridge
90 . . . Local network
92 . . . Clients
94 . . . Clients
96 . . . Access point
98 . . . Hot spot

### DETAILED DESCRIPTION OF THE INVENTION

The present invention has been implemented in order to improve the efficiency in a network environment using no switching means in the above P2G type data delivery. The present invention assumes that a server is connectable to all or a part of destination clients so that the server sends a source packet to any one client by a unicast. The client having received it transfers a copy packet to a predetermined local multicast address. All the clients receiving delivery service can access this multicast address. For this reason, it is possible for all the clients to constantly receive the packets regardless of which client first received the packet directly from a delivery server.

Furthermore, according to the present invention, the server randomly changes the client for sending the packet first so that, the larger the number of clients becomes, the lower the frequency with which each client sends the copy packet to the multicast address becomes in inverse proportion to the number of clients. For this reason, the load among the clients is shared, and at the same time, it becomes easier to cope with a specific client participating in or pulling out of the network. It is also possible, as the clients operate in collaboration to allow sharing of digital content, to eliminate necessity of additional investments such as a secondary server in a corresponding collision domain.

To be more specific, the present invention provides a system for delivering digital content via a first network and a second network, a digital content delivery system including:
a server connected to the above described first network for sending the digital content; and
a client constituting the above described second network connected to the above described first network for receiving and providing the above described digital content, wherein:
the above described server includes a client list for storing address identification values of the clients participating in a predetermined domain of the above described second network;
means for randomly selecting client identification values registered with the above described client list; and
means for sending to a selected client a packet as a minimum unit for constituting the above described digital content in response to the above described selection, and

the above described client includes means for creating a copy packet from the above described packet as the minimum unit received from the above described server and multicasting the above described copy packet to the second network to which the above described client is attributed.

The above described server includes means for sending a multicast address value to the above described client. The above described server includes means for detecting that the above described client is connected to the above described second network and updating the above described client list. The above described server includes means for deleting the address identification value of the above described client from the above described client list according to a response from the above described client receiving the above described packet as the minimum unit. The above described server includes a domain list storing an environment of the above described second network used to change the means for selecting the client to which the packet as the minimum unit should be sent next. The above described second network includes at least a wireless local network environment and the above described client is a portable terminal networked in the wireless environment.

The present invention also provides a method for delivering the digital content via the first network and the second network, a digital content delivery method including the steps of:
having the packet as the minimum unit for constituting the digital content received via the above described first network by the client attributed to the above described second network to be selected by a server connected to the above described first network in response to the network environment of the above described second network;
having a copy packet of the above described packet as the minimum unit created by the above described client having received the above described packet as the minimum unit; and
having the above described created copy packet multicast from the above described client to the second network to which the above described client is attributed and having the above described packet as the minimum unit shared by all the clients attributed to the above described second network.

The above described client of the present invention is selected by randomly selecting address identification values of the above described client registered with the client list held by the above described server. The above described client list of the present invention is updated according to connection of the above described client to the above described second network and the response of the above described client. It includes a step of having a multicast address value for multicasting in the above described second network obtained by the above described client from the above described server.

Furthermore, the present invention also provides a server used for the system for delivering the digital content via the first network and the second network, the above described server including:
means for randomly selecting from the client list, the client identification values registered with the above described client list for storing address identification values of the clients participating in a predetermined domain of the above described second network;
means for sending to the selected client the packet as the minimum unit for constituting the above described digital content in response to the above described selection; and
means for detecting a connection of the above described client to the above described second network and the response from the above described client receiving the above described packet as the minimum unit so as to update the above described client list by adding or deleting the address identification values to or from the above described client list.

The server of the present invention further includes means for sending to the above described client the multicast address value to be used in the above described second network. The above described server includes the domain list storing the environment of the above described second network used to change the means for selecting the client to which the packet as the minimum unit should be sent.

The present invention also provides a computer-executable program for controlling a computer as the server for executing the digital content delivery method via the first network and the second network, the above described program causing the computer to execute the steps of:
randomly selecting from the client list, the client identification values registered with the above described client list for storing the address identification values of the clients connected to the predetermined domain of the above described second network;
having the packet as the minimum unit for constituting the above described digital content sent to the selected client in response to the above described selection;
detecting the connection of the above described client to the above described second network and a response from the above described client receiving the above described packet as the minimum unit so as to update the above described client list by adding or deleting address identification values to or from the above described client list; and
sending to the above described client a multicast address value to be used in the above described second network.

The present invention further causes the above described server to execute a step of referring to the domain list for storing environment information on the above described second network used to change the means for selecting the client to which the packet as the minimum unit should be sent.

Furthermore, the present invention provides the computer-executable program for controlling the computer as the client for delivering the digital content via the first network and the second network, the above described program causing the computer to execute the steps of:
having the packet as the minimum unit for constituting the digital content received by the computer selected in response to the network environment of the above described second network from the server connected to the above described first network;
having the copy packet of the above described packet as the minimum unit created by the above described computer having received the above described packet as the minimum unit; and
having the above described created copy packet multicast from the above described computer to the second network to which the above described computer is attributed and having the above described received packet as the minimum unit shared by all the computers attributed to the above described second network.

The present invention can cause the above described computer to execute a step of obtaining a multicast address value sent from the above described server for multicasting in the above described second network.

### AN ADVANTAGEOUS EMBODIMENT

Section I: Overview Description of P2G Type Data Delivery

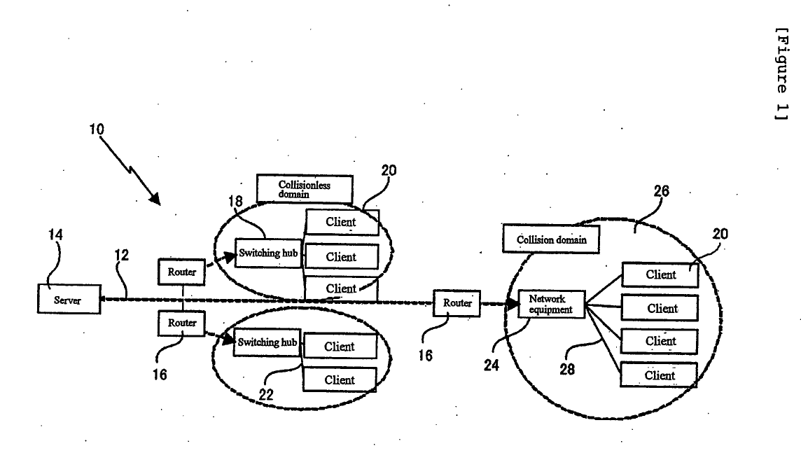

FIG. 1 is a schematic diagram of a digital content delivery system 10 of the present invention. The digital content delivery system 10 of the present invention comprises a server 14 connected to a network 12 and a plurality of clients 20 connected to the network 12 via networking equipment such as a router 16 and a switching hub 18 respectively. A network such as the Internet, WAN or LAN can be named as the network 12 shown in FIG. 1. And a public telephone circuit, ISDN, ADSL, optical communication, terrestrial radio communication and so on can be used as communication media for constituting the network. The server 14 delivers digital content to the clients 20 via the network 12 and a network 22 by means of the present invention.

As for the digital content to be delivered in the present invention, it is possible to name MPEG2, MPEG4 or moving image data of a higher dimension which needs to simultaneously provide the content to the plurality of clients in real time. With regard to the digital content in the present invention, it is also possible to use multimedia data comprising a plurality of types of digital data such as the moving image data and sound data, text data and so on other than the moving image data. According to the present invention, it is also possible to deliver arbitrary digital data including software and so on other than the multimedia data.

The clients 20 are also connected to the network 12 via the router 16, switching hub 18 and so on. The clients 20 are also identified by the server 14 by the method of having predetermined domain numbers and so on allocated based on domain identification values such as IP addresses allocated to the same router 16. According to an advantageous embodiment of the present invention, also the clients 20 form the network 22 connected by a P2P connection in the predetermined domain so as to allow mutual communication between the clients in the domain.

Furthermore, other than the collisionless domain formed by using the switching hub 18, the present invention comprises a collision domain 26 constituted, for instance, as the domain by a network equipment 24 branched from the network 12 via the router 16 and having no switching function such as a terminal and a repeater hub/bridge for the wireless local area network (LAN). To be more precise, the collision domain 26 is constituted, for instance, as a local network 28 using the wireless LAN such as a wireless local network or an infrared local network, a wired LAN such as Ethernet®, an optic LAN mutually connected by an optical fiber and so on.

The server 14 usable for the present invention can be comprised of a personal computer or a workstation. The personal computer or workstation can be the one capable of having a CPU such as PENTIUM®: Intel Corp. or a CPU compatible with it mounted thereon and also capable of operating an operating system such as WINDOWS®: Microsoft Corp.), WINDOWS® NT (Microsoft Corp.), OS/2 (trademark, International Business Machines Corp.), AIX (trademark, International Business Machines Corp.), UNIX® or LINUX. However, it is not limited thereto.

The client 20 usable for the present invention is the personal computer or workstation applicable to the above-mentioned server 14. Besides, as for the collision domain 26 in particular, a highly portable computer such as a notebook-sized personal computer, a PDA or a cellular phone can be used.

The digital content delivery system shown in FIG. 1 is indicated as the one in which the collisionless domain using the switching means and the collision domain coexist. However, all the domains of the present invention may be the collision domains.

To schematically describe the content delivery process of the digital content delivery system 10 of the present invention shown in FIG. 1, the server 14 is constituted to decompose the moving image data into a plurality of streams and further decompose one stream into a plurality of packets so as to send them from the server 14 to the selected clients 20 as source packets without redundancy. According to the present invention, the source packet means a packet as a minimum unit necessary for reconstituting the digital content, and it means the packet not to be sent redundantly to the predetermined domain unless a failure occurs in particular as described later. The source packet has selection means for selecting the client changed by depending on the collisionless domain or the collision domain. However, it is sent to at least one client attributed to the predetermined domain. The client having received the source packet sends a copy of the received source packet (hereafter, referred to as a copy packet) to another client included in that domain.

The client having received the copy packets accumulates them for a predetermined period. After the predetermined period elapses, the client reconstitutes the streams by using packet identifiers attached to the packets as serial numbers for instance so as to have the digital content displayed or reproduced on the client. To be more specific, according to the present invention, the server 14 allows the clients belonging to a predetermined group to share the same digital content without sending redundant packets to the clients of one group. The collisionless domain and the above-mentioned content delivery process are described in detail in the Patent Document 1, and so no more description thereof will be given.

Section II: Content Delivery to the Collision Domain and Sharing Thereof

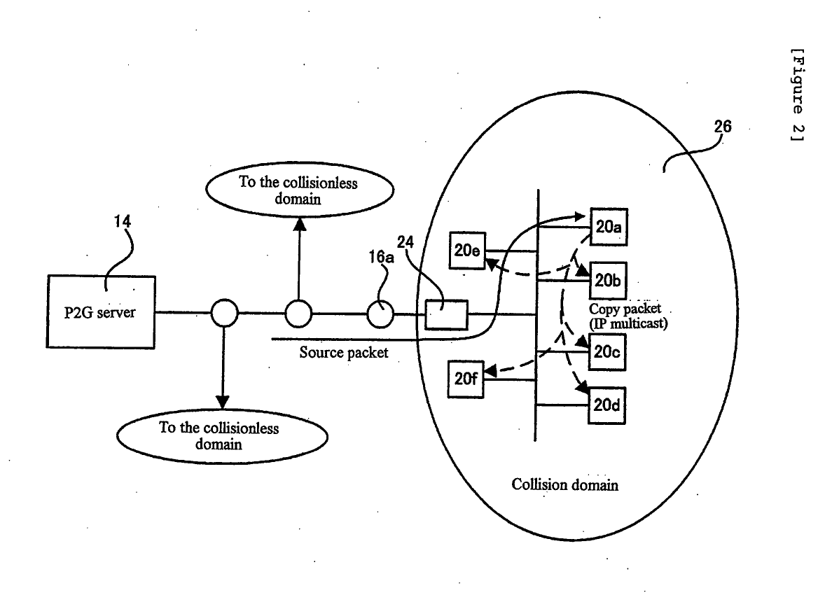

FIG. 2 shows an embodiment of sending of the source packet and copy packet in the case of sending the source packet from the server 14 to the collision domain 26 in the digital content delivery system shown in FIG. 1. In FIG. 2, the arrow shown in full line indicates transmission of the source packet, and the arrow shown in broken line indicates the transmission of the copy packet. The embodiment shown in FIG. 2 is shown by omitting the collisionless domain and other collision domains for the sake of description.

The source packet sent out from the server 14 to the network 12 gets to the network equipment 24 having no switching function via a router 16a. The source packet includes an address identification value such as an IP address of a client 20a, for instance, as one of the clients 20a to 20f attributed to the collision domain randomly selected by the server. The network equipment 24 sends out the received source packet to the local network 28. After being sent out to the local network 28, the source packet is read to the client having the address identification value included therein.

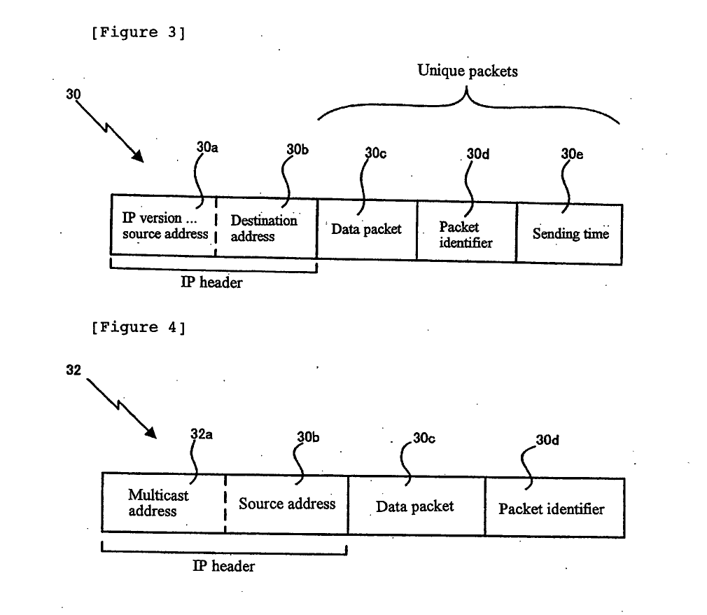

FIG. 3 shows a schematic configuration of a source packet 30 usable for the present invention. As shown in FIG. 3, the source packet 30 sent out from the server 14 comprises IP header information. The IP header information comprises IP version information, a source address 30a and a destination address 30b. Furthermore, it shows that the source packet 30 includes a data packet 30c for performing the delivery and a packet identifier 30d given to the source packet 30 as a unique serial number. The source packet 30 has a sending time 30e at which the server 14 sent the source packet 30 added thereto. According to the present invention, it is possible to constitute the above-mentioned data packet 30c, packet identifier 30d and sending time 30e as a unique packet created at an application level.

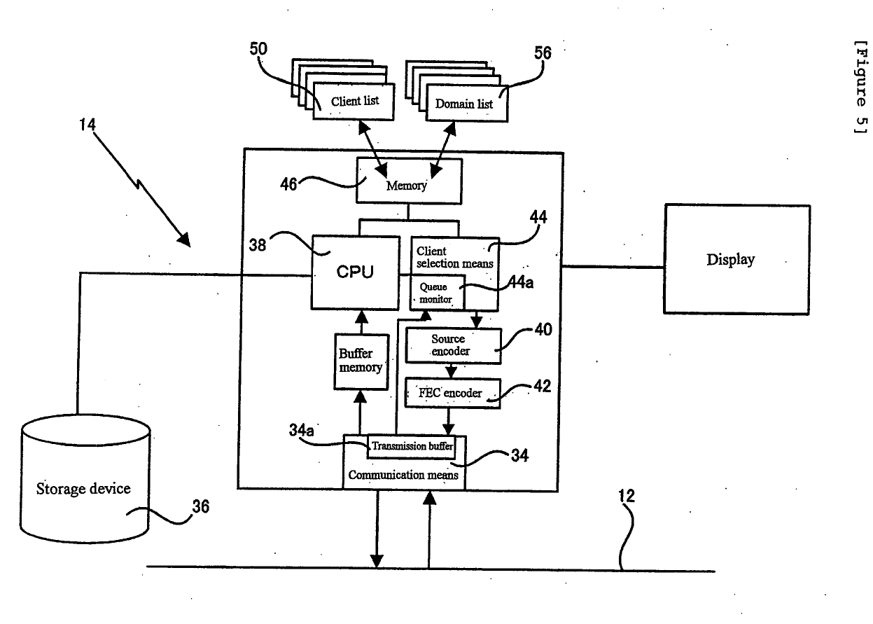

FIG. 4 shows a schematic embodiment of a copy packet 32 usable for the present invention. The copy packet 32 generally has the received data packet 30c and packet identifier 30d copied and also includes a multicast address 32a such as 239.xxx.yyy.zzz capable of multicasting in the collision domain and a source address 32b of the client 20a having sent out the copy packet 32. The copy packet 32 shown in FIG. 4 is sent out to the local network 28, and is then obtained by the other clients 20b to 20f connected to the local network 28 shown in FIG. 2 so as to be stored in a buffer memory.

The above-mentioned process of the clients 20a to 20f is repeated until the packets accumulated in the buffer memory become enough to reproduce the original digital content at appropriate intervals. Thereafter, integrity of the packets is determined by using packet identification values, and the packets are sorted as required so that each client reconstitutes the digital content. The present invention does not designate any specific format and application for constituting the source packet. However, it is possible, for instance, to create the source packet in a “.wav” file format and use the application such as MediaPlayer (trademark), for instance, as a reproduction program.

Section III: Server and Clients of the Present Invention and Processes Performed by them

FIG. 5 is a diagram showing a schematic configuration of the server 14 of the present invention. The server 14 shown in FIG. 5 is connected to the network 12 via a communication means 34 such as a modem, a DSU or a network interface card, and delivers the digital content to the clients not shown. The server 14 has programs, lectures, greetings, educational programs and so on stored in a storage device 36 for instance. Although the digital data of the present invention could advantageously be constituted as the multimedia data including the above-mentioned moving image data, it may be anything else as long as it is the digital data.

In the case where the server 14 sends out the digital content to the clients, a CPU 38 reads the digital content from the storage device 36 first and sends the read digital content to a source encoder 40 and an FEC encoder 42. On receiving the digital data, the source encoder 40 and FEC encoder 42 perform a streaming process to the digital data, and further divide one stream into the packets of a predetermined size. The server 14 comprises a client selection means 44 for selecting the address identification values of the clients to be sent depending on a network environment of the domain to send them.

The client selection means 44 obtains client identifiers by referring to a client list 50 and a domain list 56 stored in a memory 46. Thereafter, the source packet 30 is generated by adding the obtained address identification value, source address, sending time, packet identification value and so on. The generated source packet 30 is delivered to the client attributed to a randomly selected collision domain via the communication means 34. In this case, the server 14 only sends the packet as the minimum unit to a predetermined collision domain, and does not send a redundant source packet.

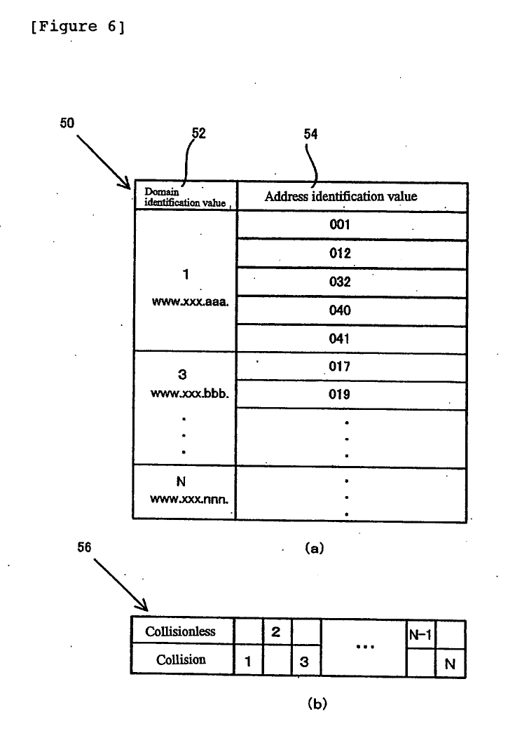

FIG. 6 shows the embodiments of the client list (a) and domain list (b) usable for the present invention. The client list 50 shown in FIG. 6(a) is based on a domain identification value 52 given to each collision domain, and has domain numbers 1 to N registered therewith. And the client list 50 has an address identification value 54 of the client registered therewith, which client is attributed to that domain, connected to the domain at the time and having issued a request “Joinrequest” to participate in the P2G type data delivery.

The domain list 56 shown in FIG. 6(b) can be constituted as a hash table or a database comprising the network environment of the domain and a domain identification value such as a domain number. When a network manager of the domain requesting the P2G type data delivery registers the network environment of the domain with the server 14 on registering with the P2G type data delivery, the domain list 56 can be created on the server 14 in advance so as to be stored likewise in the form of the hash table or database.

According to the present invention, it is possible, as shown in FIG. 6, to render the client list 50 as a single client list and register all the domains therewith so as to constitute the domain list 56 separately. According to another embodiment of the present invention, it is possible to constitute the client list and domain list as the same table and provide a collision environment identification column to this table for instance so as to have server processes such as updating the table and selecting a different client performed in a stage in which it receives a connection request or a participation request or an after-mentioned response packet from the client.

According to the present invention, it is possible to implement the client list 50 with a configuration such as the hash table. The client list 50 is updated by adding or deleting the address identification values. As for the process in the case of adding the address identification value of the client, it is possible, in the stage in which the client is connected to the local network 26 forming the collision domain, to issue a participation notice “Joinrequest” to the server 14. And when the server 14 sends an “IPmulticastaddress” in response to the participation notice “Joinrequest” and subscription of the IP multicast address is completed for the client, it can be added to the client list 50.

According to another embodiment of the present invention, in the case where the client can subscribe to the applicable multicast address without having the IP multicast address sent by the server 14, it is possible to update the client list 50 by adding the address identification value to it in the stage in which the client is connected to the domain and in the stage in which a “helloacknowledgment” is notified from the client to the server 14.

Hereafter, a detailed description will be given as to processing of the server 14 including a functional process of the client selection means 44 for selecting the client in the collision domain. On receiving the request for participation in the P2G type data delivery such as the “Joinrequest, the server 14 analyzes a participation request packet and identifies the client having issued the participation request. In this case, to clearly describe the present invention, the description will be given on the assumption that the participation request was issued from the client attributed to the collision domain. If the domain identification value such as a subnetwork mask of the domain to which the client is attributed is identified from the participation request, the server 14 randomly selects the address identification value such as the IP address of the client attributed to the domain identification value so as to set it as the destination address. Thereafter, the server 14 generates the source packet 30 having the configuration shown in FIG. 3 and including the address identification value of the selected client, and sends it out to the network 12 via the communication means 34 so as to send the source packet 30 to the clients 20.

In the case where the server 14 selects the client identification value from the client list, it is possible, according to a specific embodiment of the present invention, to select a randomly registered client identification value as to the collision domain. According to another embodiment of the present invention, it is also possible to randomly select the source packet from the client identification values left after excluding just one client identification value of which source packet was sent just before it. According to the above-mentioned other embodiment, it is possible to securely eliminate a possibility of having the source packet sent again to the client performing the process of creating the copy packet from the source packet sent just before it. Therefore, it allows more efficient content delivery to be performed to the collision domain.

According to an advantageous embodiment of the present invention, the communication means 34 comprises a transmission buffer 34a as shown in FIG. 5. The transmission buffer 34a has a queue 34b stored therein for each client to which the source packet 30 was sent. The client selection means 44 comprises a queue monitor 44a for monitoring a remaining amount of the queue allocated to each client.

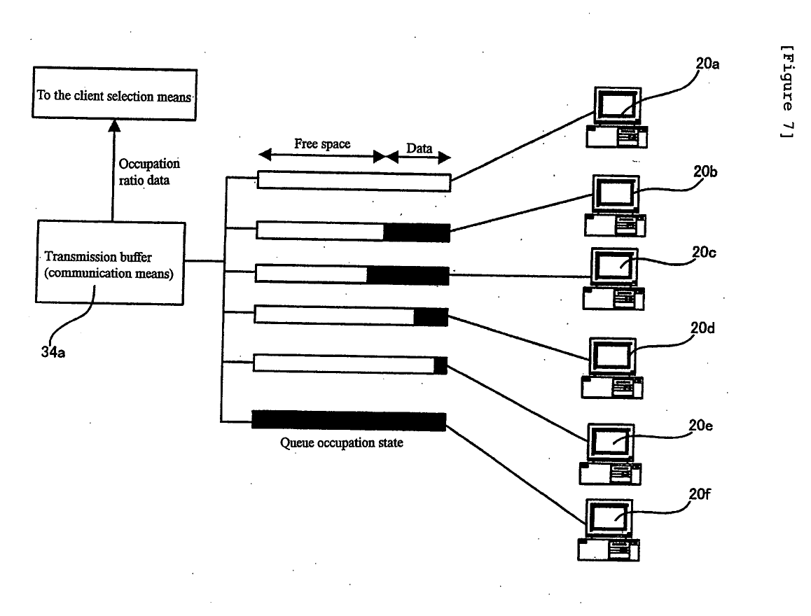

FIG. 7 schematically shows a state of the queue 34b stored in the transmission buffer 34a of the present invention and a response state of the clients 20a to 20f corresponding thereto by using the state after a preset time interval t from a time tₒ at which a transmission instruction was given. As for an occupation ratio of the queue stored in the transmission buffer 34a, FIG. 7 shows that, as indicated by the client 20f, the more delayed a receiving process of the source packet 30 is, the further the queue occupation ratio due to transmission data increases at the stage after the time t elapses from a time t_{ob} at which the source packet 30 was sent. In FIG. 7, the remaining data is indicated by a black area. FIG. 7 also shows that, as for the client 20a capable of promptly processing reception, the queue occupation ratio is reduced after the time t elapses from a transmission instruction t_{of} of the source packet 30.

According to an advantageous embodiment of the present invention, the queue monitor 44a included in the client selection means 44 can calculate the queue occupation ratio of each client and render a value thereof as a response indicator of the client. This response indicator corresponds to a good response of the client if the value is small, and indicates a low response of the client if it is large. As will be described further in detail later, it is possible, by using the response indicator, to designate a next client to send the source packet in the collisionless domain and monitor a breakaway and a down state of the client in the collisionless domain and collision domain.

According to a further embodiment of the present invention, it is possible to use Round Trip Time (RTT) in order to monitor the response state of the client as described in Japanese Patent Application No. 2002-303850. According to this embodiment, the server 14 monitors the response packet for sending a notice that the source packet 30 was received from the client. The response packet may include a copy of the packet identification value of the received packet, a copy of the sending time attached to the source packet 30 and so on in addition to the IP header information described as to the source packet 30. According to the present invention, the server 14 calculates the RTT by using the response packet, and checks a load state and a connection state of the client in the local network at that time. As for a concrete process for this purpose, the source packet 30 sent to a predetermined destination is stored in an adequate memory of the server 14, and a time difference between the sending time recorded in each response packet and the time then at the server 14 is calculated at the stage in which the server 14 receives the response packet so as to have the RTT obtained by the server 14. Furthermore, it is also possible, according to the present invention, to use the RTT as an indicator directly indicating the connection state of the client to the extent that there is no inconvenience in particular.

According to a specific embodiment of the present invention, the server 14 thereafter calculates RTT⁻¹ to render it as the response indicator of the client. The client selection means 44 compares the value of RTT-⁻¹ to a threshold T for the response as to the client attributed to the collision domain. As for the client in the collision domain, it may be determined that, in the case of RTT⁻¹≦T, the client is down or has broken away from a hot spot, for instance.

According to the present invention, the response of the client is determined by using the above-mentioned response indicator, and it is detected that reliability of the client is lowered in the delivery of the source packet 30 based on comparison with a predetermined threshold. As for the present invention, the response indicator of the above-mentioned standard was described as a concrete embodiment. It is possible, however, to obtain the response indicator otherwise by using the methods and means already known. As described above, in the case where the reliability of the response is lowered apart from the method of generating the response indicator, the sharing of the source packet 30 cannot be assured. For this reason, the server 14 reads the source packet 30 from the memory and allocates another client identification value of the client list 50 so as to generate a retry packet. The retry packet is sent to a newly selected client. The server 14 can monitor the response packet from the client having been sent the retry packet so as to securely perform the P2G type data delivery.

The client having shown an abnormal delay based on the response indicator is in a state of being excessively processed or capable of no response at all, and so it is not suited to having the source packet delivered thereto. For this reason, in the case where the above-mentioned abnormal delay is detected as to the collision domain in the specific embodiment of the present invention, the server 14 deletes the address identification value of the client from the client list 50 and thereby updates the client list so as not to repeat a redundant sending process of the above-mentioned source packet.

According to the present invention, even if the client having given the abnormal delay is deleted from the client list, the copy packet is sent by the IP multicast in the collision domain. For this reason, even in the case where the client breaks away from the hot spot or even in the case where the response delays by some process, the copy packet is securely sent to the client connected to the local network then so that no serious problem arises to the P2G type data delivery.

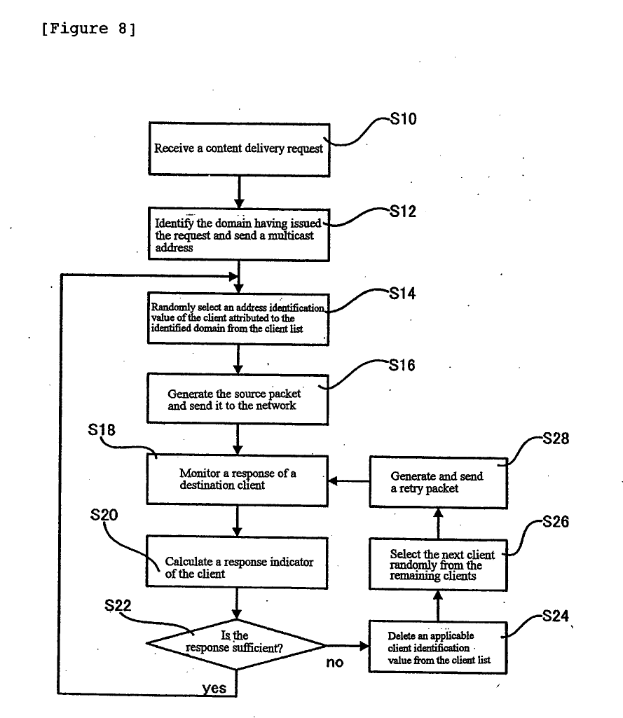

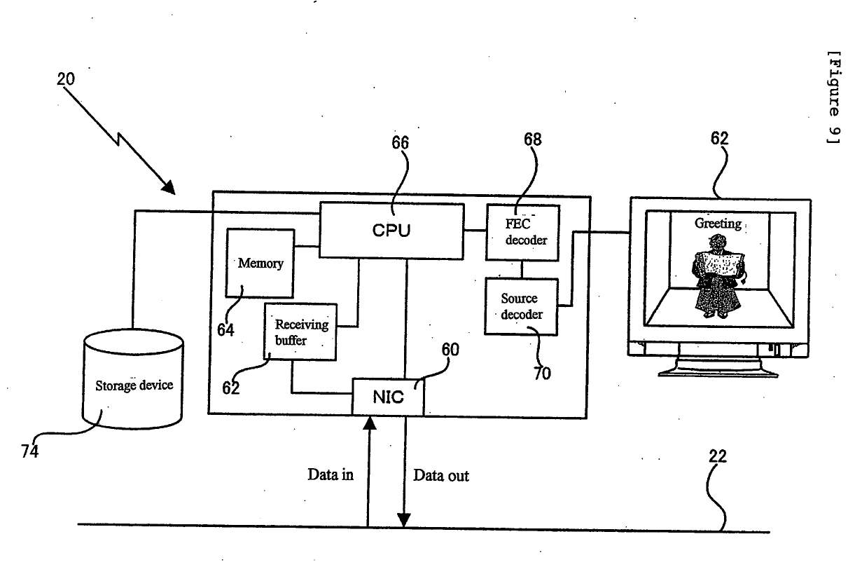

FIG. 8 shows a schematic flowchart of the process performed by the server 14. The server 14 in a step S10 receives the “Joinrequest” requesting the P2G type data delivery from the client, for instance. In a step S12, it sends the multicast address to the client having issued the “Joinrequest” so as to allow sending and receiving in the domain of the packet. In a step S14, it randomly selects one address identification value from the client list. And in a step S16, it has the source packet generated and sends it to the network.

In a step S18, the server 14 monitors the response state of the client by using the queue occupation ratio or RTT. In a step S20, it has the response indicator calculated from the queue occupation state or RTT, and has it stored in the memory. If determined that the response is insufficient or there is a possibility of a breakaway from the network (no) in a step S22, the server 14 deletes the address identification value of the applicable client from the client list in a step S24. Next, in a step S26, it randomly selects the next address identification value from the clients still registered in order to avoid a loss of the source packet. In a step S28, it reads the source packet stored in an adequate memory of the server 14 and creates the retry packet by adding a new address identification value so as to send it to the network. And it monitors the response packet again in the step S18 to continue the process. If determined that the response of the client is sufficient based on the response indicator (yes), the server 14 returns the process to the step S18 and performs the sending process of the next source packet.

FIG. 9 is a diagram showing the configuration of the client 20 usable for the present invention. The client 20 shown in FIG. 9 is connected to the local network 28 via a network interface card (NIC) 60. The client 20 further comprises a receiving buffer 62 and a memory 64 such as an RAM. The receiving buffer 62 holds the received source packet and copy packet until a reconstitution process of the streams of the moving image data is started.

According to the present invention, the receiving buffer 62 can be constituted as a ring buffer for writing the received packet to the address corresponding to the packet identification value on receiving the received packet each time. The client 20 also comprises a central processing unit (CPU) 66, a source decoder 68 and an FEC decoder 70. According to the present invention, however, the FEC decoder is not always required. The CPU 66 is driven by a clock, and reads the packets accumulated in the receiving buffer 62 for a predetermined period so as to send them to the FEC decoder 70 and source decoder 68 and reconstitute the moving image data equivalent to one stream. The reconstituted moving image data equivalent to one stream is displayed or reproduced on a display 72 and is provided to a user of the client.

The moving image data displayed or reproduced to the user may either be deleted from the client 20 or be stored in a storage device 74 such as a hard disk, a magneto-optical disk or a magnetic tape by holding all the streams from the start to the end of the digital content in the memory 64.

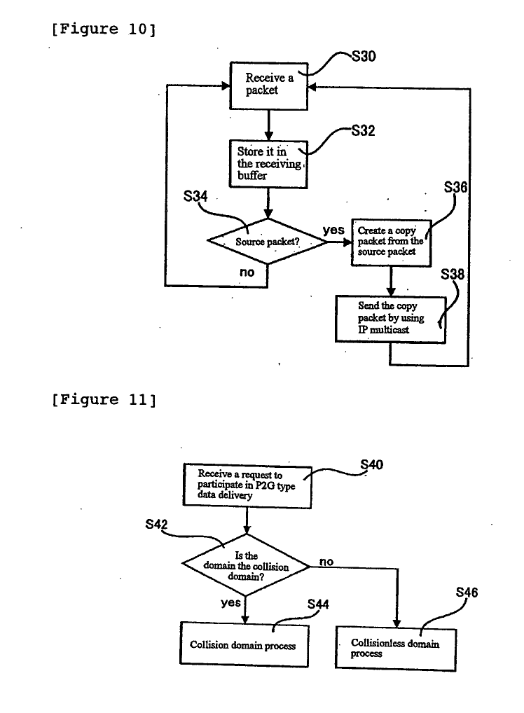

FIG. 10 shows a schematic flowchart of the process up to receiving the source packet 30 and sending out the copy packet in the client 20 according to the present invention. The process of the client shown in FIG. 10 is started by receiving the packet in the step S30. In a step S32, the received packet is stored in the receiving buffer. In a step S34, it is determined whether or not the received packet is the source packet. In the case where the received packet is the source packet (yes), the client 20 goes ahead with the process in a step S36, and creates the copy packet of the source packet and stores it in an adequate transmission buffer or the like. In a step S38, it sends out the copy packet to the local network by using the IP multicast, and allows the packet to be shared by the other clients. In the case where the received packet is not the source packet (no), it returns the process to the step S30, and receives the next packet. It becomes possible, by using the server 14 and the client 20 for performing the above-mentioned process, to perform good P2G type data delivery to the collision domain.

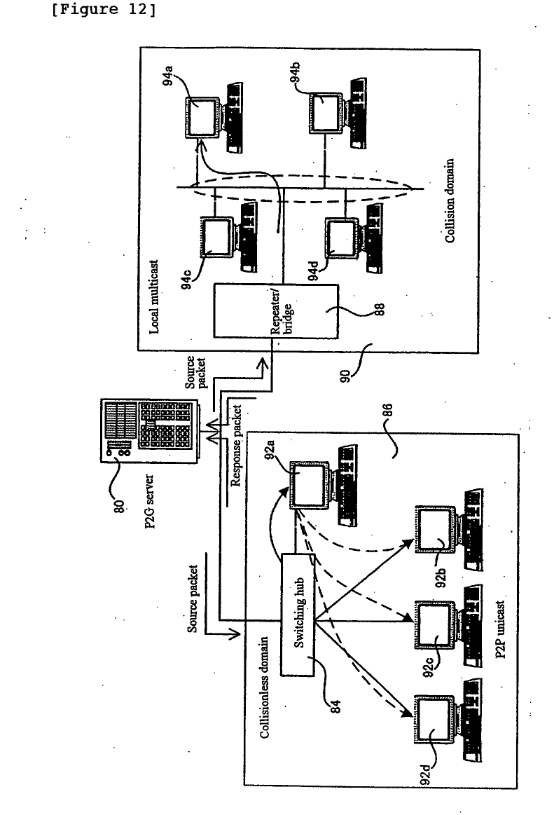

FIG. 11 is a diagram showing the process of the server for performing the P2G type data delivery in a network system in which the collisionless domain and the collision domain are mixed. According to the present invention, a great difference between the processes of the collisionless domain and the collision domain is the method of selecting the client for sending the source packet.

The process of the server 14 shown in FIG. 11 is started from a step S40, and it receives the “Joinrequest” requesting the participation to the P2G type data delivery from the client 20. The server 14 obtains the identification value of the domain to which the client 20 is attributed from the received “Joinrequest” in a step S42, and refers to the domain list 56 so as to determine whether it is the collisionless domain or the collision domain. If determined to be the Joinrequest” from the collision domain (yes) in the determination in the step S42, the server 14 calls a collision domain process in a step S44. If determined not to be the “Joinrequest” from the collision domain (no) in the step S42, it calls a collisionless domain process in a step S46 so as to have adequate data delivery performed in response to the domain capability.

FIG. 12 is a diagram showing a more concrete embodiment of the content delivery system of the present invention. As for the embodiment shown in FIG. 12, it is shown that a local network 86 routed by a switching hub 84 is connected with a local network 90 routed by a repeater/bridge 88 via a network 82 such as the Internet from a P2G server 80. The LAN 86 is constructed as a collisionless network environment mutually connected by Ethernet® using the standards such as 10BASE-T, 100BASE-TX, and Gigabit Ethernet®, for instance, via the switching hub 84. In FIG. 12, the local network 90 is constructed as the network environment with a possibility of a collision using the repeater/bridge 88 although it is in the environment mutually connected by Ethernet®.

The P2G server 80 further comprises another client list corresponding to the collisionless domain. However, it will not be described in detail because it is not the gist of the present invention. This client list has IP address information, for instance, which is the address identification values of the clients in the collisionless domain and effective throughput corresponding to overhead of the clients obtained by using the response packet on sending the source packet last time registered therewith.

As described above, the P2G server 80 generates the response indicators with clients 92a to 92d in order to perform the P2G type data delivery to the local network 86 in the collisionless environment. And it sequentially selects the client which is most reliable, that is, of low overhead so as to send the source packet. The clients 92a to 92d having received the source packet create the copy packet of the source packet, and deliver the copy packet by the unicast by using the addresses of the other clients included in the domain.

Furthermore, a description will be given as to the case where the P2G server 80 sends the source packet to the collision domain. In the case of sending the source packet, the P2G server 80 randomly selects the address identification values of the clients registered with the client list. Thereafter, it unicasts the source packet to a client 94a attributed to the collision domain. The client 94a having received the source packet creates the copy packet having an IP multicast address attached thereto and multicasts the copy packet to the local network 90 so as to allow the packet to be shared by the other clients 94b to 94d. Irrespective of which domain it is attributed to, the client having received the source packet can send the response packet to the P2G server 80 and notify the P2G server 80 of the successful reception of the source packet, effective throughput or connection state.

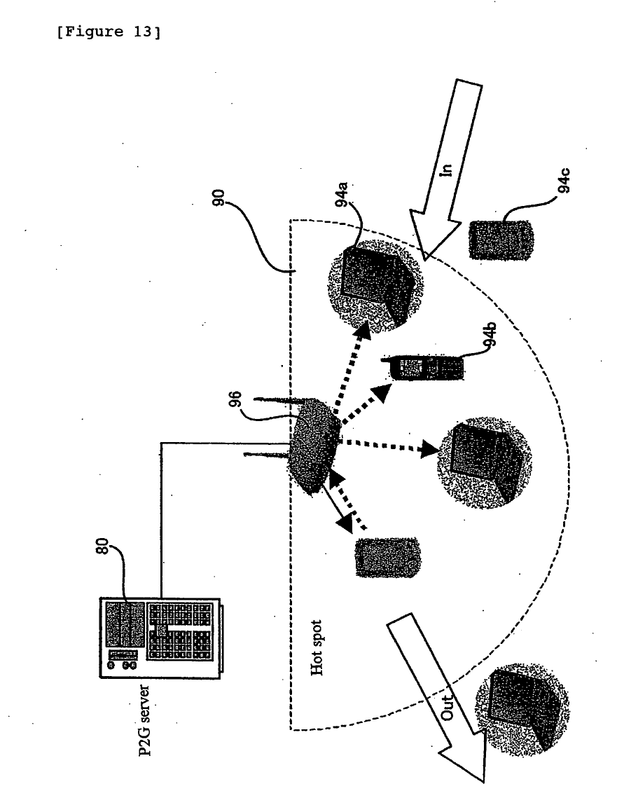

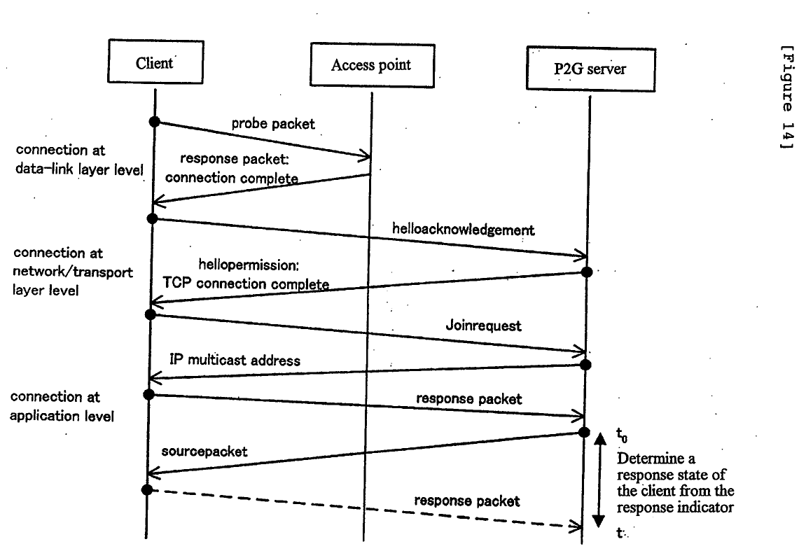

FIG. 13 shows the embodiment in the case where the local network 90 constituting the collision domain of the present invention is the network using wireless communication. As shown in FIG. 13, a hot spot 98 is defined centering on an access point 96 in the environment of the local network 90 using wireless communication. The clients 94 included in the hot spot 98 such as a notebook-sized computer 94a, a cellular phone 94b and a PDA 94c are capable of intercommunication via the access point 96. A problem in the embodiment shown in FIG. 12 lies in high mobility of the clients 94. As for the wireless local network 90 shown in FIG. 13, the clients 94 break away and participate at any time compared to the local network comprised of the repeater/bridge 88 so that use of the P2G type data delivery of the present invention can be applied with specific effect.

Hereafter, a description will be given as to the details of a P2G type data delivery protocol in the case of using the wireless local network 90 for the present invention. FIG. 14 is a diagram showing the process from establishment of a communication session to sending and receiving of the source packet in chronological order as to transactions among the clients 94, access point 96 and P2G server 80 in the case where the collision domain is constituted as the wireless local network. The term “wireless” used in the present invention broadly means that it is not “wired” and includes optical communication, radio communication and so on, and as for a communication protocol, any protocol known so far such as Bluetooth may be used. As for the P2G type data delivery, it will be described on the assumption that it is performed to a service provider in each user domain registered by the user by obtaining a predetermined IP multicast address or necessary access information.

The embodiment in the wireless local network will be described by using FIG. 14. The client finds the access point on reaching the hot spot. For this purpose, it is possible, for instance, to use Active Scanning defined by IEEE802.11 and a connection method (Accession protocol) whereby the access point periodically sends a beacon packet and the client responds to that call. The embodiment shown in FIG. 14 takes the Active Scanning method thereof, and the client sends a probe packet to the access point first. The access point having received the probe packet returns a response packet to the client, and establishes a connection in a data link layer.

The client obtains the information such as the IP address and port number of the server in advance from a network administrator and so on, and has it stored in an adequate nonvolatile memory. The client establishes the connection with the access point at a data link layer level, and then sends a “helloacknowledge” to the P2G server at a network layer/transport layer level to establish a TCP session with the P2G server. On receiving the “helloacknowledge,” the P2G server obtains an address identifier of the client, and adds the address identifier to the client list so as to establish the TCP session between the client and the P2G server by sending a “hellopermission” to the client.

The client having received the “hellopermission” sends the “Joinrequest” to participate in the P2G type data delivery to the P2G server. The P2G server having received the “Joinrequest” notifies the client of the multicast address allocated to the collision domain to the domain in advance, and establishes the session for the P2G type data delivery at an application layer level. Thereafter, the P2G server randomly selects the client or obtains the response indicator by using the time t from the time tₒ at which the source packet was sent, and selects the client so as to send a source packet “sourcepacket” to the selected client. The time t is a predetermined threshold time set up as the response indicator on the server 14 in the case of using the indicator calculated based on the queue occupation ratio as described above. And in the case of using the RTT as the response indicator, it is the time for receiving the response packet as shown in broken line.

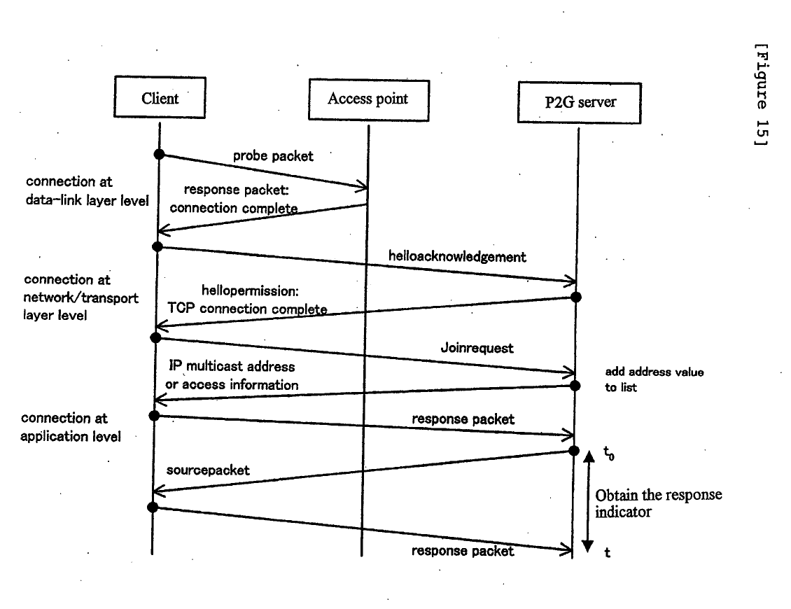

FIG. 15 is a diagram showing the transactions in the case of including the collisionless domain and the collision domain in chronological order. If the client enters the hot spot, it establishes the connection with the access point and registers with the P2G server by sending and receiving the “helloacknowledgment” and “hellopermission” as shown in FIG. 15. The P2G server has a network map stored therein, and selects the process of the P2G type data delivery on receiving the “helloacknowledgment.” And in the embodiment shown in FIG. 15, it sends necessary access information such as the multicast address to the collision domain or P2G tree structure information or domain identification to the collisionless domain so as to allow the P2G type data delivery through the same process as that shown in FIG. 14.

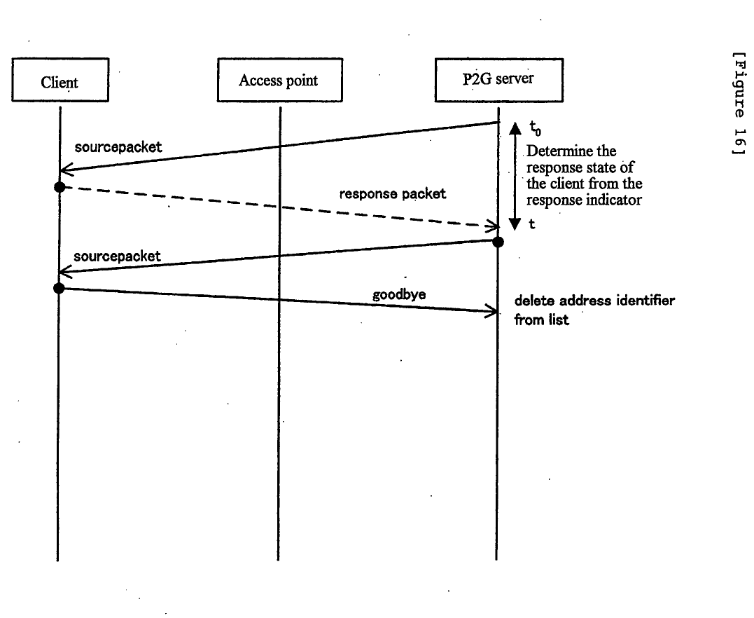

A description will be given by using FIGS. 16 to 18 as to the transaction in the case of killing the connection between the client and the P2G server connected to the wireless local network 90. The client and the P2G server receive the P2G type data delivery according to a session establishment protocol described in FIGS. 14 or 15. Generally, there are the following three cases when the client breaks away from the P2G type data delivery. First, it is the case where the client shuts down normally. Secondly, it is the case where it is cut from the P2G server, such as when the P2G server finishes the delivery. And thirdly, it is the case where the client comes out of the hot spot such as the case of using the wireless local network or the case of abnormal termination of the client.

FIG. 16 shows the first case where the client shuts down normally. It is assumed that, in the case shown in FIG. 16, the client prefers to shut down for such reasons as getting home or leaving the desk for another task. If the user performs a shutdown operation to the client, the client sends a “goodbye” command to the P2G server, for instance, to notify that it will be disconnected. On receiving the “goodbye” command, the P2G server obtains the address identifier of the client shutting down from the IP header information. Furthermore, the P2G server retrieves and deletes the applicable address identifier from the client list in order to have no source packet sent thereafter.

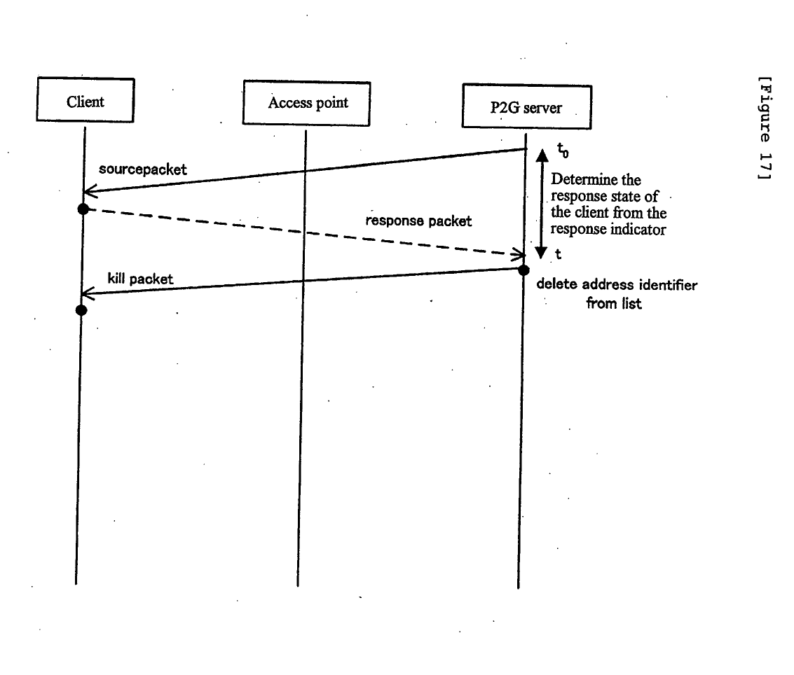

FIG. 17 shows the case of finishing the delivery from the P2G server to a specific client. In the case shown in FIG. 17, the P2G server tries to disconnect from the client depending on convenience of the P2G server or the client. In this case, the P2G server sends a “kill” command to the client for instance, and deletes the address identifier of the applicable client from the client list.

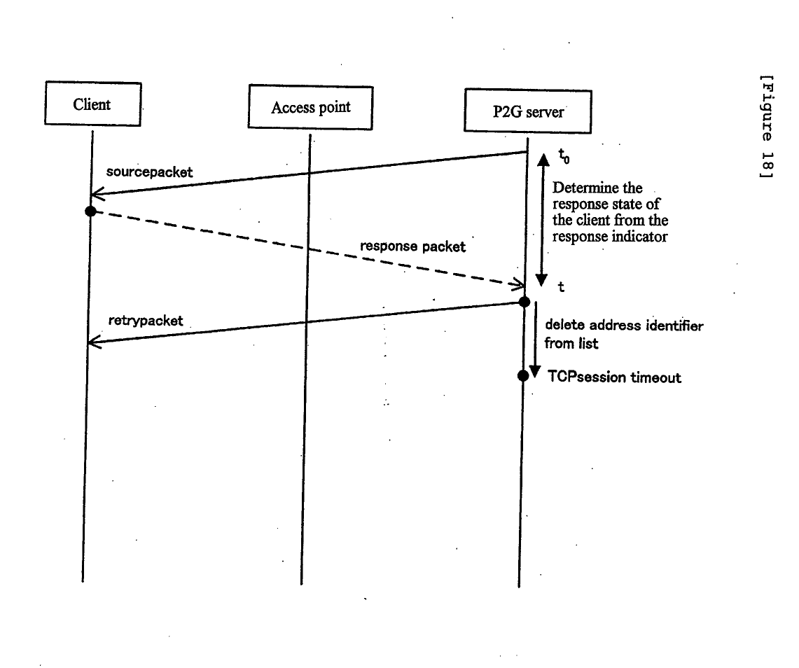

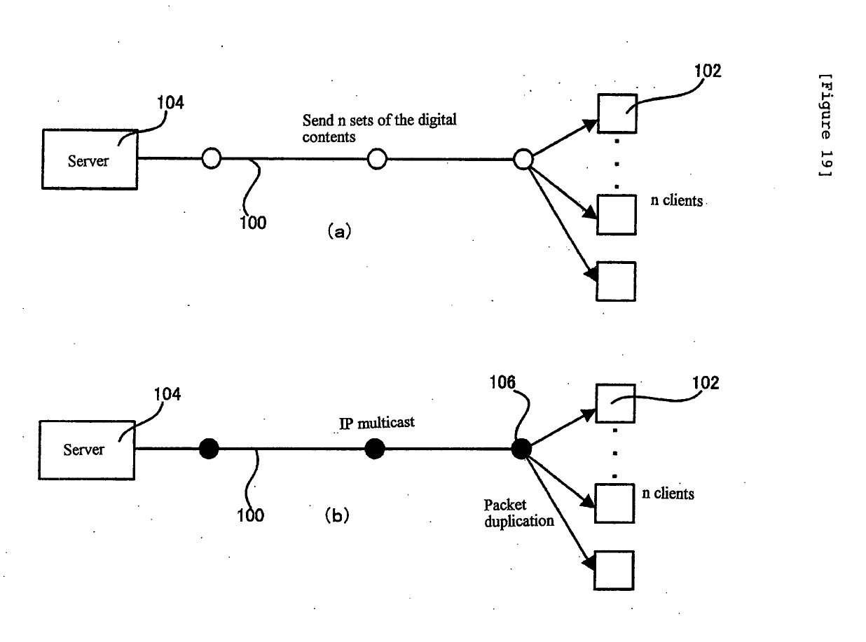

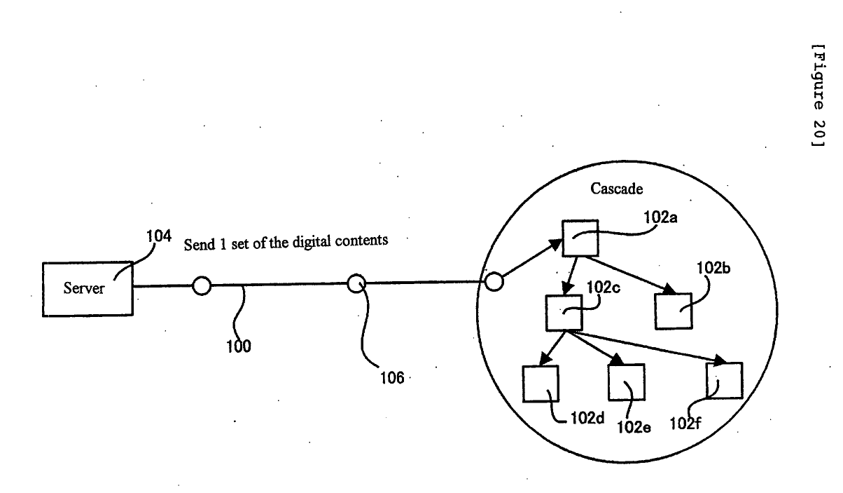

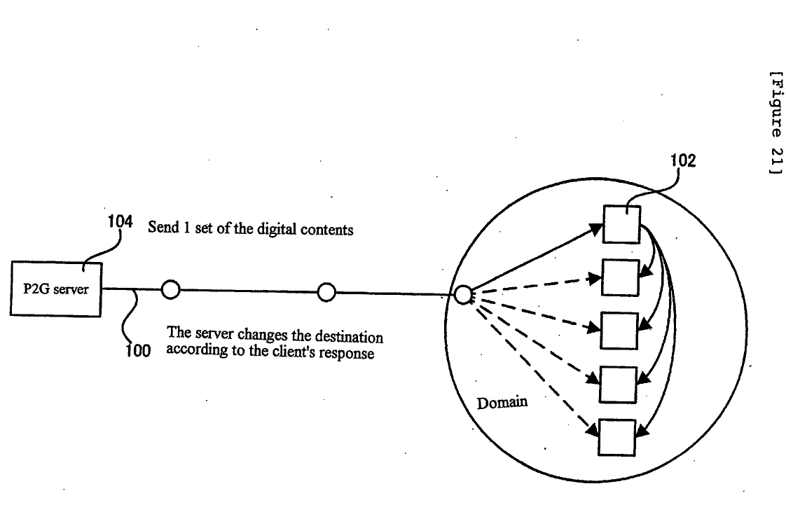

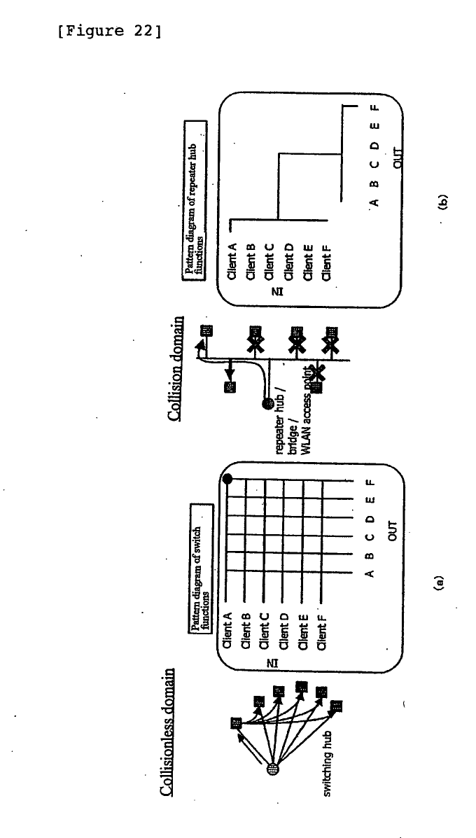

FIG. 18 explains the process in the case where the client abnormally terminates or breaks away from the hot spot. As shown in FIG. 18, the process in this case is performed by sending the source packet from the P2G server and using the response indicator thereto of the client. After sending the source packet, the P2G server makes a determination by comparing the response indicator to the predetermined threshold of the client based on the queue occupation ratio or the RTT obtained from the response packet. And if determined that some abnormality occurred to the client based on the response indicator, the address identification value of the client is deleted from the client list in the collision domain. As for the collisionless domain, it is handled by selecting the next client in increasing order of the small overhead indicated by the response indicator, and it is not necessary to delete the address identification value from the client list about the collisionless domain. Thereafter, the retry packet is sent to another client in the same domain so that the sent source packet will not be lost so as to secure data integrity. Furthermore, in the case where the “helloacknowledgment” from the client does not arrive again after time elapses, the TCP session itself is finished as timeout to complete the session.

According to the present invention, it is possible, by performing the above-mentioned process, to deliver low-cost data with efficiency and high reliability to the client connected to the local network of any form known so far.

As for the means or portion for implementing each of the above-mentioned functions of the present invention, it is possible to constitute it as software or a software module group described in a computer-executable program language. And it is not always necessary to constitute it as the functional block described in the drawings.

The above-mentioned program for performing the digital content delivery of the present invention can be described by using various programming languages such as C language, C++ language and Java®. The code describing the program of the present invention can be held on computer-readable storage media such as the magnetic tape, flexible disk, hard disk, compact disk (CD), magneto-optical disk and digital versatile disk (DVD).

The present invention has been described so far by using the concrete embodiments described in the drawings. However, the present invention is not limited to the above-mentioned specific embodiments, and various modified examples, other embodiments and any component known so far may be used to the extent that the present invention is effective. The variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form. Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. A digital content delivery system for delivering digital content via a first network and a second network, said system comprising:
a server connected to said first network for sending the digital content; and
a client constituting said second network connected to said first network for receiving and providing said digital content, wherein:
said server comprises a client list for storing address identification values of the clients participating in a predetermined domain of said second network;
means for randomly selecting client identification values registered with said client list; and
means for sending to a selected client a packet as a minimum unit for constituting said digital content in response to said selection, and
said client comprises means for creating a copy packet from said packet as the minimum unit received from said server and multicasting said copy packet to the second network to which said client is attributed.

2. The digital content delivery system according to claim 1, wherein said server comprises means for sending a multicast address value to said client.

3. The digital content delivery system according to claim 1, wherein said server comprises means for detecting that said client is connected to said second network and updating said client list.

4. The digital content delivery system according to claim 1, wherein said server comprises means for deleting the address identification value of said client from said client list according to a response from said client receiving said packet as the minimum unit.

5. The digital content delivery system according to claim 1, wherein said server comprises a domain list storing an environment of said second network used to change the means for selecting the client to which the packet as the minimum unit should be sent next.

6. The digital content delivery system according to claim 1, wherein said second network comprises at least a wireless local network environment and said client is a portable terminal networked in the wireless local network environment.

7. A method for delivering digital content via a first network and a second network, said method comprising the steps of:
having a packet as a minimum unit for constituting the digital content received via said first network by a client attributed to said second network to be selected by said server connected to said first network in response to a network environment of said second network;
having a copy packet of said packet as the minimum unit created by said client having received said packet as the minimum unit; and
having said created copy packet multicast from said client to the second network to which said client is attributed and having said packet as the minimum unit shared by all the clients attributed to said second network.

8. The method according to claim 7, wherein said client is selected by randomly selecting address identification values of said client registered with a client list held by said server.

9. The method according to claim 8, wherein said client list is updated according to connection of said client to said second network and a response of said client.

10. The method according to claim 7, wherein it comprises a step of having a multicast address value for multicasting in said second network obtained by said client from said server.

11. A server used for a system for delivering digital content via a first network and a second network, said server comprising:
means for randomly selecting from a client list, client identification values registered with said client list for storing address identification values of the clients participating in a predetermined domain of said second network;
means for sending to a selected client a packet as a minimum unit for constituting said digital content in response to said selection; and
means for detecting a connection of said client to said second network and a response from said client receiving said packet as the minimum unit so as to update said client list by adding or deleting address identification values to or from said client list.

12. The server according to claim 11, comprising means for sending to said client a multicast address value to be used in said second network.

13. The server according to claim 11, wherein said server comprises a domain list storing an environment of said second network used to change the means for selecting the client to which the packet as the minimum unit should be sent.

14. A computer-executable program for controlling a computer as a server for executing a digital content delivery method via a first network and a second network, said program causing the computer to execute the steps of:
randomly selecting from a client list, client identification values registered with said client list for storing address identification values of the clients connected to a predetermined domain of said second network;
having a packet as a minimum unit for constituting said digital content sent to a selected client in response to said selection;
detecting a connection of said client to said second network and a response from said client receiving said packet as the minimum unit so as to update said client list by adding or deleting address identification values to or from said client list; and
sending to said client a multicast address value to be used in said second network.

15. The program according to claim 14, wherein said server is caused to execute a step of referring to a domain list for storing environment information on said second network used to change the means for selecting the client to which the packet as the minimum unit should be sent.

16. A computer-executable program for controlling a computer as a client for delivering digital content via a first network and a second network, said program causing the computer to execute the steps of: having a packet as a minimum unit for constituting the digital content received by the computer selected in response to a network environment of said second network from a server connected to said first network;
having a copy packet of said packet as the minimum unit created by said computer having received said packet as the minimum unit; and
having said created copy packet multicast from said computer to the second network to which said computer is attributed and having said received packet as the minimum unit shared by all the computers attributed to said second network.

17. The program according to claim 16, wherein said computer is caused to execute a step of obtaining a multicast address value sent from said server for multicasting in said second network.

18. A method for delivering digital content via a first network and a second network, said method comprising the steps of:
having a packet as a minimum unit for constituting the digital content received via said first network by a client attributed to said second network to be selected by said server connected to said first network in response to a network environment of said second network;
having a copy packet of said packet as the minimum unit created by said client having received said packet as the minimum unit; and
having said created copy packet multicast from said client to the second network to which said client is attributed and having said packet as the minimum unit shared by all the clients attributed to said second network.

19. A computer program product comprising a computer usable medium having computer readable program code means embodied therein for causing a digital content delivery system for delivering digital content via a first network and a second network, the computer readable program code means in said computer program product comprising computer readable program code means for causing a computer to effect the functions of:
a server connected to said first network for sending the digital content; and
a client constituting said second network connected to said first network for receiving and providing said digital content, wherein:
said server comprises a client list for storing address identification values of the clients participating in a predetermined domain of said second network;
means for randomly selecting client identification values registered with said client list; and
means for sending to a selected client a packet as a minimum unit for constituting said digital content in response to said selection, and
said client comprises means for creating a copy packet from said packet as the minimum unit received from said server and multicasting said copy packet to the second network to which said client is attributed.

20. A computer program product comprising a computer usable medium having computer readable program code means embodied therein for causing functions of a server used for a system for delivering digital content via a first network and a second network, the computer readable program code means in said computer program product comprising computer readable program code means for causing a computer to effect the functions of:
means for randomly selecting from a client list, client identification values registered with said client list for storing address identification values of the clients participating in a predetermined domain of said second network;
means for sending to a selected client a packet as a minimum unit for constituting said digital content in response to said selection; and means for detecting a connection of said client to said second network and a response from said client receiving said packet as the minimum unit so as to update said client list by adding or deleting address identification values to or from said client list.

21. An article of manufacture comprising a computer usable medium having computer readable program code means embodied therein for causing delivery of digital content via a first network and a second network, the computer readable program code means in said article of manufacture comprising computer readable program code means for causing a computer to effect the steps of:
having a packet as a minimum unit for constituting the digital content received via said first network by a client attributed to said second network to be selected by said server connected to said first network in response to a network environment of said second network;
having a copy packet of said packet as the minimum unit created by said client having received said packet as the minimum unit; and
having said created copy packet multicast from said client to the second network to which said client is attributed and having said packet as the minimum unit shared by all the clients attributed to said second network.

22. An article of manufacture comprising a computer usable medium having computer readable program code means embodied therein for causing delivery of digital content via a first network and a second network, the computer readable program code means in said article of manufacture comprising computer readable program code means for causing a computer to effect the steps of:
having a packet as a minimum unit for constituting the digital content received via said first network by a client attributed to said second network to be selected by said server connected to said first network in response to a network environment of said second network;
having a copy packet of said packet as the minimum unit created by said client having received said packet as the minimum unit; and
having said created copy packet multicast from said client to the second network to which said client is attributed and having said packet as the minimum unit shared by all the clients attributed to said second network.

23. A program storage device readable by machine, tangibly embodying a program of instructions executable by the machine to perform method steps for delivering digital content via a first network and a second network, said method steps comprising the steps of claim 7.

24. A program storage device readable by machine, tangibly embodying a program of instructions executable by the machine to perform method steps for delivering digital content via a first network and a second network, said method steps comprising the steps of claim 18.

25. A computer program product comprising a computer usable medium having computer readable program code means embodied therein for causing delivery of digital content via a first network and a second network, the computer readable program code means in said computer program product comprising computer readable program code means for causing a computer to effect the functions of claim 1.

26. A computer program product comprising a computer usable medium having computer readable program code means embodied therein for causing delivery of digital content via a first network and a second network, the computer readable program code means in said computer program product comprising computer readable program code means for causing a computer to effect the functions of claim 11.
